(19) United States
(12) Patent Application Publication
(10) Pub. No.: US 2003/0013068 A1
(43) Pub. Date: Jan. 16, 2003

(54) Trans-tissue extension apparatus

(76) Inventor: Neal B. Gittleman, Houston, TX (US)

Correspondence Address: Ezra L. Schacht, 1620 West Main Street, Houston, TX, 77006, US

(21) Appl. No.: 09/906,190

(22) Filed: Jul. 16, 2001

(51) Int. Cl. A61C 8/00

(52) U.S. Cl. 433/173; 433/172

(57) ABSTRACT

An apparatus for achieving a variable height trans-tissue extension (TTE) useful in matching a prosthesis to an underlying implant fixture to preserve soft tissue shape, improve hygienic care and prevent a dissimilar metal, electrolytic effect below the tissue line. The trans-tissue extension consists of a set of aligned, non-rotating spacers with a through-hole for an attachment screw. The full height is achieved by using the tallest of the spacers, while a shorter extension is formed from the use of a shorter spacer. This simplifies the needed inventory of variable height abutments by anticipating a wide variety of needs. The trans-tissue extension is adaptable to single implants, bar undercases, ball-end, snap-on prostheses and casting or brazing forms.

### BACKGROUND OF THE INVENTION

The dental patient, with great variability of reconstructive needs, challenges the implant specialist to provide a cosmetic, hygienic and structurally sound replacement. In particular, variability in the depth of structural bone along with the thickness of the overlying soft tissue can vary greatly along the arc of a multiple restoration, as well as from patient to patient. If a portion of the jaw bone has been edentulous for a long enough time, the underlying bone recession will require a taller abutment to elevate the plane of the restoration. Additionally, a properly seated implant may be at a depth of several millimeters below the soft tissue line. The need to place the abutment at the proper elevation is remedied by this invention.

The present trend is toward the sterile pre-packaging of kits of dental implant abutments with necessary mounting hardware. However, at the present time, these kits do not contain a set of variable height trans-tissue extensions (TTEs), also known as trans-tissue extensions. In particular, these kits do not contain a selection of a number of lengthening elements with heights varying from one to five or more millimeters. The time and effort necessary to select a specific combination of trans-tissue extensions (TTEs) for a full restoration might require an inventory of many prepackaged and sterilized components. By combining a full set of TTE spacer elements in a kit with the proper abutment and fastening hardware, the practitioner can discard those spacers not necessary for achieving the required height of the abutment. The manufacturer only needs to make the primary abutment and standardized TTEs.

Inventor submits an application for an apparatus to achieve a variable height trans-tissue extension (TTE) useful in matching a prosthesis to underlying implant fixtures to preserve soft tissue shape, improve hygienic care, improve the distribution of load bearing forces and prevent a dissimilar metal, electrolytic effect below the tissue line. The trans-tissue extension consists of a set of clocking, non-rotating spacers with a through-hole for an attachment screw. The full height is achieved by using the longest of the spacers, while a shorter extension is achieved by using a shorter spacer. This simplifies the needed inventory of trans-tissue extensions by anticipating a wide variety of needs. The unused TTEs are discarded. These spacers can be produced from bio-compatible titanium alloys and manufactured with well known techniques.

This trans-tissue extension is adaptable to single implants, bar undercases, ball-end, snap-on prostheses and casting or brazing forms. These prosthesis undercase elements are maintained in planar alignment. The proximal (bottom) end of the TTE spacer has a single retaining thread internal to the through-hole to keep it loosely coupled to its mounting screw and prevent it from dropping out of sight during assembly with the implant.

The top of the TTE spacer has a surface having a polygonal recess to accommodate a matching polygonal projection on a non-rotating abutment. This polygonal recess can accommodate the head of the screw hardware. The perimeter surface of the TTE can be cylindrical, frusta-conical, or of non-circular, of tapered or straight cross-section that more closely resembles the natural tooth cross-section being replaced.

The bottom of the TTE spacer has a surface with a polygonal projection to match the recess located in the top surface of a typical implant. The lower polygonal projection of the TTE has a turn or two of an internal thread matching that of the screw used to mount the abutment to the implant. This serves to loosely hold the TTE upon the screw during assembly. Two or more TTEs can be stacked so that additional height is achieved. Depending upon the bone loss in the edentulous areas and the thickness of the soft tissue, 4 to 6 mm or more of extension may be needed.

The implant should have a long enough run of internal thread to accommodate the varying depth of mounting screw penetration resulting from the choice of TTE height.

A stack of one or more TTEs can have a non-cylindrical exterior, each subsequent member matching the next element with a smooth exterior transition to prevent soft tissue irritation. This smooth exterior preserves the profile of the natural tooth and aids in proper hygiene.

### A BRIEF DESCRIPTION OF THE DRAWINGS

FIG. 1 details an elevated, exploded view of an abutment and four trans-tissue extensions of variant height with mounting screw;

FIG. 2 shows a perspective, exploded view of an slanted abutment and two typical trans-tissue extensions, one viewed with a quarter section removed; and

FIG. 3 details a perspective view of several trans-tissue extensions with abutments and implant.

### A DETAILED DESCRIPTION OF THE DRAWINGS

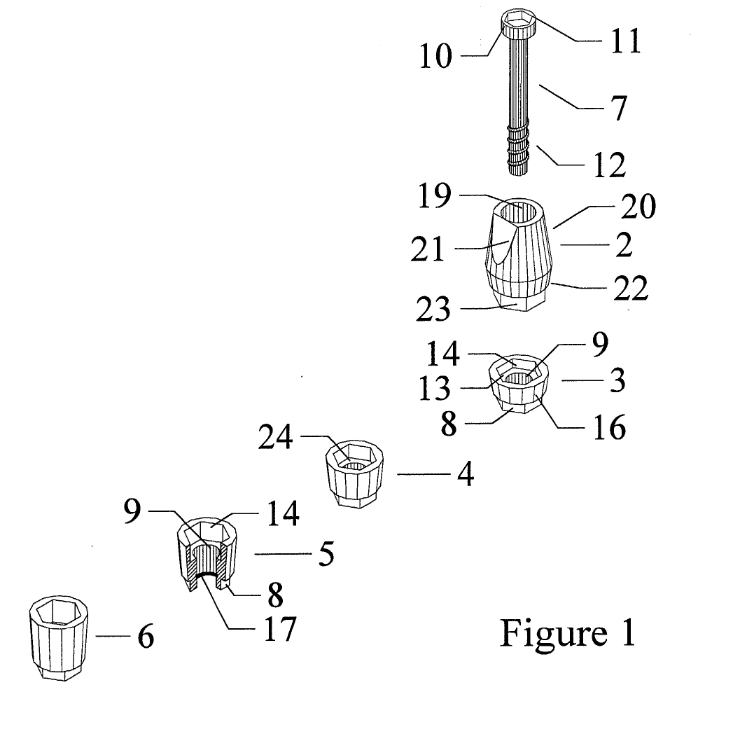

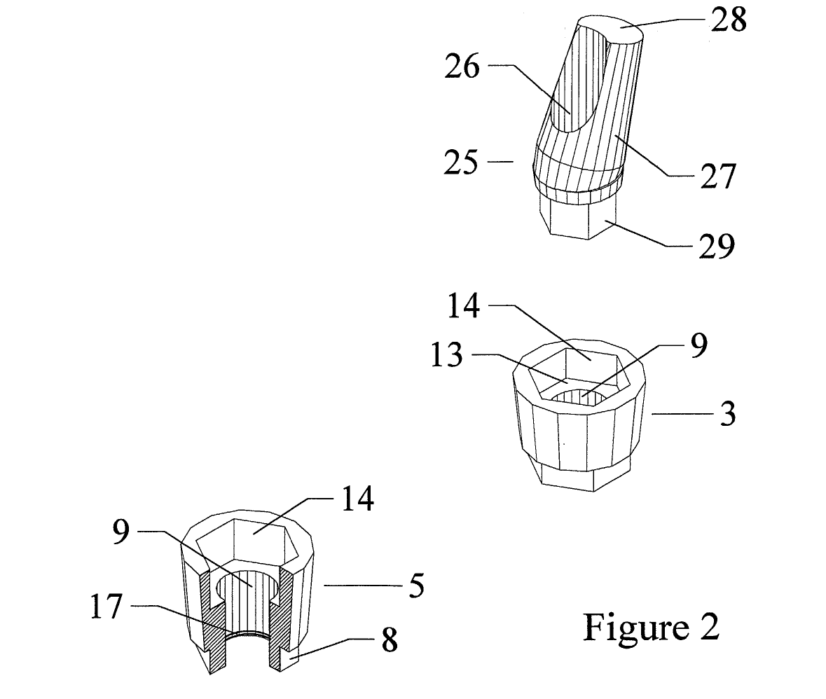

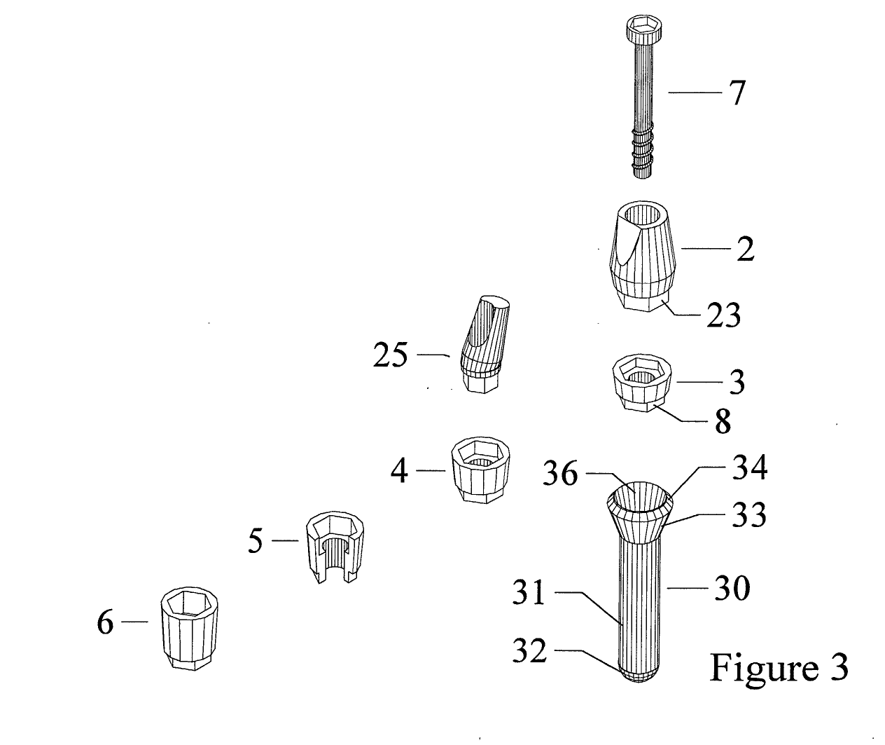

The combined apparatus shown in FIGS. 1 and 3 shows a series of trans-tissue extensions 3, 4, 5 and 6, all with cylindrical through-hole 9 and each with a polygonal (hexagonal) upper recess 14 and lower polygonal (hexagonal) projection 8. Machine screw 7 is formed with threads 12 in the lower portion of the screw shaft. The screw shaft can freely turn within recess 14 and the through-hole 9 of the TTE spacers. The machine screw is driven by a tool inserted in the polygonal (shown as hexagonal) recess 11. All TTE spacers are equipped with an internal thread 17 of a single turn or so in the hexagonal projection 8 to allow the threads 12 on the machine screw hold the assembly loosely together prior to installation in the implant. Typical TTE spacer 5 shares it's features with TTE spacers 3, 4 and 6. Typically, TTE 6 would have an extension height of 5 mm, TTE 5 would be 4 mm in extension height, and others shorter still. Upper surface 13 and internal polygonal surface 14 of typical TTE spacer 3 is designed to mate with a polygonal projection on the base of mounting element 2 to prevent rotation in a clocked and locked fashion. Mounting element 2 is shown as a straight abutment, but could be a brazing element or waxing sleeve, a ball-head screw assembly or cross-bar assembly, any of which can be mounted with appropriate hardware to the implant using the through-hole in the mating TTE. Abutment 2 is shown with a countersunk through-hole 19, conic tapers 20 and 22, flat surface 21 and polygonal projection 23. Polygonal projection 23 mates snugly within any of the recesses 14 on the upper surface 13 of the TTEs. FIG. 2 includes an offset abutment 25 with lower polygonal projection 29 that can mate with any of the TTEs of varying heights. Offset abutment 25 has a top surface 28 and a canted conic section 27. Countersunk mounting hole 26 accommodates mounting screw to hold the abutment to the implant with spacer 3 intervening.

FIG. 3 shows the lower polygonal projection 8 featured on all the TTEs shown which mates with a matching internal surface 36 of a typical implant 30. The inner surface 36 is equipped with a polygonal recess to clock and lock with polygonal projection 8. It is to be understood that other families of implants are equipped with an external polygonal projection and will require a TTE with a lower mating recess, instead of a mating projection. This implant is shown with a flared upper lip 34 and conic section 33 connected to cylinder 31 and terminating in a rounded end 32 in a manner known in the art. The shaft of screw 7 descends through abutment element 2 and typical TTE 3 to mate with internal threads located within the cylindrical barrel 31 of the implant.

It must be noted that some implant families have a top polygonal projection instead of a polygonal recess. Under those circumstances the TTE would have a corresponding matching recess on the lower surface and a top polygonal projection on the upper surface. The intention of the TTE is, in effect, to raise the upper surface features of the implant to a new height near the soft tissue line while maintaining the coplanar orientation of these upper surface features.

A typical spacer 5 is shown with quarter section removed, in more detail in FIGS. 1 and 2. The lower polygonal projection 8 fits in perfect alignment with the upper polygonal recess located on the top of an implant. The upper polygonal recess 14 accommodates the polygonal projection on the bottom of an abutment. Cylindrical through-hole 9 has a lower machine thread 17 located on the inner surface of polygonal projection 8 to retain a machine screw for assembly.

In FIG. 1, peripheral surface 16 of the spacer 3 is shown with a slight taper. Each peripheral surface 16 of TTEs 3, 4, 5 and 6 can have a non-cylindrical cross-section. Each of the surfaces can form a portion of a truncated cone or mimic the emergence profile of the natural tooth being replaced, as long as the transitions between external peripheral surfaces of the implant, the TTE spacer and the abutment are smooth. This prevents any form of soft tissue irritation. They must be made from the same alloy to avoid electrolytic disturbances caused from the “battery” formed by dissimilar metals in a conductive solution like saliva.

What is claimed is:

1. An apparatus for accurately positioning and aligning a dental prosthesis to a dental implant at a desired trans-tissue height comprising:
an aligning, non-rotating extension with a through-hole for an attachment machine screw;
having a lower polygonal projection on a lower surface;
having an upper polygonal recess on an upper surface; and
having a lower peripheral surface in smooth surface transition with the dental implant and an upper peripheral surface in smooth transition with the dental prosthetic abutment.

2. An apparatus as recited in claim 1 comprising a trans-tissue extension having a peripheral surface shaped to mimic the natural tooth being replaced.

3. An apparatus for accurately positioning and aligning a dental prosthesis to a dental implant at a desired trans-tissue height comprising:
an aligning, non-rotating extension with a through-hole for an attachment machine screw;
having a lower polygonal recess on a lower surface;
having an upper polygonal projection on an upper surface; and
having a lower peripheral surface in smooth surface transition with the dental implant and an upper peripheral surface in smooth transition with the dental prosthetic abutment.
